(19) United States
(12) Patent Application Publication
(10) Pub. No.: US 2016/0043880 A1
(43) Pub. Date: Feb. 11, 2016

(54) GATEWAY COMMUNICATION FILTER AND GATEWAY COMMUNICATION FILTER CONFIGURATION METHOD THEREOF

(71) Applicant: proeasy network solutions co., LTD., Hsinchu County (TW)

(72) Inventor: Hsing-Hung Lu, Hsinchu County (TW)

(21) Appl. No.: 14/525,226

(22) Filed: Oct. 28, 2014

(30) Foreign Application Priority Data
Aug. 5, 2014 (TW) 103126771

(51) Int. Cl. H04L 12/28; H04W 8/26

(52) U.S. Cl. CPC H04L 12/2816; H04W 8/26

(57) ABSTRACT

A gateway communication filter and a gateway communication filter configuration method thereof are provided to allow users to perform remote home control by using a mobile communication device. The method includes after a learning signal and a reset signal are simultaneously received and during a period of continually receiving the learning signal, receiving a calling signal from the mobile communication device through a mobile phone network; identifying a phone number corresponding to the mobile communication device according to the calling signal; and storing the phone number corresponding to the mobile device into a memory circuit as a manager phone number. Accordingly, the gateway communication filter allows users to perform remote home control securely and conveniently.

### CROSS-REFERENCE TO RELATED APPLICATION

This application claims the priority benefit of Taiwan application serial no. 103126771, filed on Aug. 5, 2014. The entirety of the above-mentioned patent application is hereby incorporated by reference herein and made a part of this specification.

### BACKGROUND OF THE INVENTION

1. Field of the Invention

The invention relates to a remote home control, and more particularly, relates to a gateway communication filter and a gateway communication filter configuration method thereof.

2. Description of Related Art

Since the most recent half-century, the computer field has been developed rapidly. With developments in the computer field, various automation equipments (such as washing machines, dishwashers, sweeping robots, and etc.) are widely applied in daily lives. Further, with changes in household population structure and work style, manpower dedicated to general affairs of household has also been gradually replaced by machines. Integration solutions for managing and controlling various household appliances or equipments (e.g., lightings, televisions, security systems, air conditioners, audiovisual sound systems, and etc.) are constantly re-innovated. Thus, nouns like “Smart home”, “Digital Home”, “Electronic Home”, “Home Automation” are introduced accordingly.

A home automation control system combines uses of the automated equipments together with computer software technology and applications to integrate household equipments (e.g., televisions, electric rice cooker, air conditioners, refrigerators, gas switches, alarm systems, security systems, surveillance systems, and etc.) in order to improve home comfort and home safety. The home automation control system generally includes a control system and a control host, such that users may issue control commands through the control system in order to drive various equipments through the control system. In addition, various wireless communication transmission technologies (e.g., GPRS, WiFi, WiMAX, 3G or 4G) can achieve greater flexibility and convenience by using the function of Internet connectivity in mobile equipments (e.g., mobile phones or notebook computers) to connect the Internet in order to remotely control various household equipments, enable a security mechanism, or monitor home event even if the users are in business trip, on vacation or traveling.

However, the remote control provides not only the flexibility and convenience but also security issues such as confirmation on user identity. Generally, the control host may assign a control right to a user and thereby allow the user to achieve the purpose of the remote control only after the user identity is confirmed through an authentication mechanism. A common method for the authentication mechanism includes the following. A web address is provided by a remote home control system host, so that the user may enter a user name and a password correctly through the web address in order to obtain the control right of the remote home control system host after the authentication is passed. However, it is quite often that the user may forget the user name and the password, or the user name and the password may possibly be stolen. Therefore, the invention aims to provide a convenient, secure, simple and easy method for the user to conveniently and securely perform the remote control.

### SUMMARY OF THE INVENTION

The invention is directed to a gateway communication filter and a gateway communication filter configuration method thereof, which are capable of automatically recording phone numbers of users by the machine, and identifying the phone numbers of the users, so that the mobile communication devices of the users may establish a communication channel with the gateway communication filter in order to securely perform a remote home control.

A gateway communication filter is provided according to an exemplary embodiment of the invention. The gateway communication filter includes a microprocessor unit, a gateway management circuit, a memory circuit, a first communication circuit, a learning button and a reset button. The gateway management circuit, the memory circuit and the first communication are coupled to the microprocessor unit; whereas the learning button and the reset button are coupled to the gateway management circuit. The gateway management circuit receives a reset signal when the reset button is enabled, and the gateway management circuit receives a learning signal when the learning button is enabled. In addition, after the learning signal and the reset signal are simultaneously received and during a period of continually receiving the learning signal, when the first communication circuit receives the calling signal from the mobile communication device through the mobile phone network, the gateway management circuit identifies a phone number of the mobile communication device according to the calling signal, and stores the phone number into the memory circuit as a manager phone number.

In an exemplary embodiment of the invention, the first communication circuit is further configured to receive a short message from the mobile communication device through the mobile phone network, wherein the short message contains one or more other phone numbers. The gateway management identifies the phone number of the mobile communication device according to the short message. The gateway management circuit stores the one or more other phone numbers into the memory circuit when the phone number of the mobile communication device is identified as the manager phone number.

In an exemplary embodiment of the invention, the gateway communication filter further includes an update button, coupled to the gateway management circuit. When the update button is enabled, the gateway management circuit receives an update signal, and the gateway management circuit receives an update boot code and replaces a boot code stored in the memory circuit with the update boot code in response to the update signal.

In an exemplary embodiment of the invention, the gateway communication filter further includes a second communication circuit. The gateway management circuit permits the second communication circuit to establish a communication channel with the mobile communication device and one or more other mobile communication devices corresponding to the one or more other phone numbers according to the phone number and the one or more other phone numbers stored in the memory circuit.

A gateway communication filter configuration method executed by a gateway communication filter disposed with a learning button and a reset button is provided according to an exemplary embodiment of the invention. The gateway communication filter configuration method includes: receiving a learning signal from the learning button; receiving a reset signal from the reset button; after the learning signal and the reset signal are simultaneously received and during the period of continually receiving the learning signal, receiving a calling signal from a mobile communication device through a mobile phone network; identifying a phone number corresponding to the mobile communication device according to the calling signal; and storing the phone number corresponding to the mobile device into a memory circuit as a manager phone number.

In an exemplary embodiment of the invention, the gateway communication filter configuration method further includes: receiving a short message from the mobile communication device through the mobile phone network, wherein the short message contains one or more other phone numbers; identifying the phone number corresponding to the mobile communication device according to the short message; determining whether the phone number corresponding to the mobile communication device is the manager phone number; and storing the one or more other phone numbers into the memory circuit when the phone number corresponding to the mobile communication device is the manager phone number.

In an exemplary embodiment of the invention, the gateway communication filter configuration method further includes: receiving an update signal from an update button of the gateway communication filter; receiving an update boot code; and replacing a boot code stored in the memory circuit with the update boot code in response to the update signal.

In an exemplary embodiment of the invention, the gateway communication filter configuration method further includes: permitting the gateway communication filter to establish a communication channel with the mobile communication device and one or more other mobile communication devices corresponding to the one or more other phone numbers according to the phone number and the one or more other phone numbers stored in the memory circuit.

Based on above, the gateway communication filter and the gateway communication filter configuration method thereof are provided according to exemplary embodiments of the invention, wherein the machine is capable of automatically recording the phone numbers of the users as the manager phone number by triggering a learning function of the gateway communication filter without additional man-machine interfaces. When the users intend to perform the remote home control, the users may simply make a phone call to the gateway communication filter by using the mobile communication device of the users. Then, the gateway communication filter may identify and compare whether the phone number of such phone call is the manager phone number before allowing the user to perform the remote home control further by using the mobile communication device. Accordingly, the users are able to operate the household equipments in convenient, secure, simple and easy manners.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a remote home control according to an exemplary embodiment.

FIG. 2 is a block diagram illustrating a gateway communication filter according to an exemplary embodiment.

FIG. 3 is a flowchart illustrating a gateway communication filter configuration method according to an exemplary embodiment.

FIG. 4 is a flowchart illustrating a gateway communication filter configuration method according to another exemplary embodiment.

FIG. 5 is a block diagram illustrating a gateway communication filter according to another exemplary embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

With growth of the Internet technology, if steps of confirming the user identity can be further simplified and a more secure remote control method may be provided, an automation home control system may indeed be operated more conveniently and easily. The invention is developed based on the above concept.

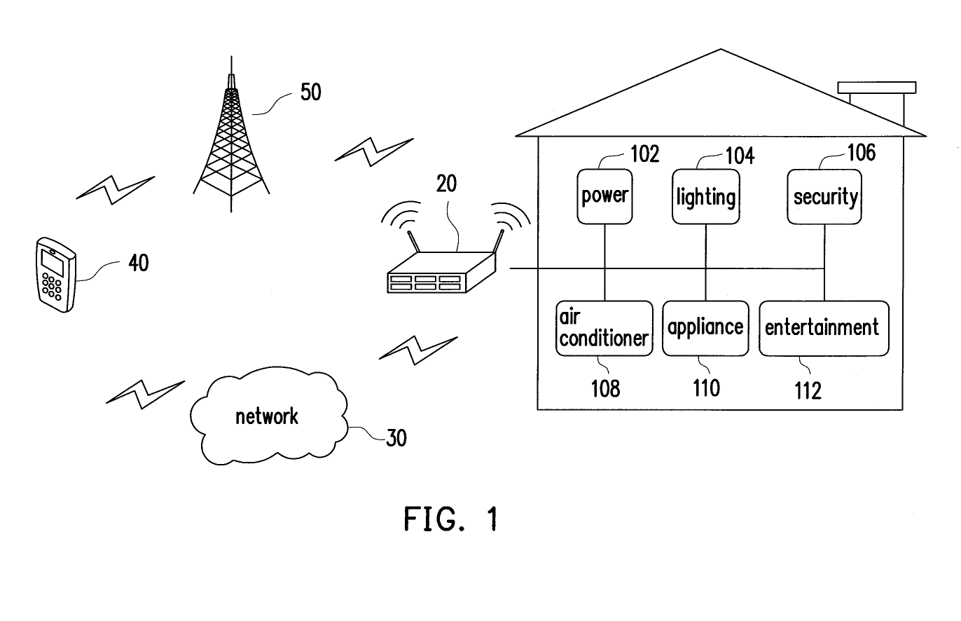

FIG. 1 is a schematic diagram illustrating a remote home control according to an exemplary embodiment.

Referring to FIG. 1, an environment of a remote home control usually includes household equipments, a gateway communication filter 20, a network 30, a mobile communication device 40 and a mobile phone network 50.

The household equipments include a power equipment 102, a lighting equipment 104, a security equipment 106, an air condition equipment 108, an appliance equipment 110, and an entertainment equipment 112. However, it should be noted that, the household equipments are not limited to the above, and the listed household equipments are not intended to limit the invention. For example, each of the power equipment 102, the lighting equipment 104, the security equipment 106, the air condition equipment 108, the appliance equipment 110, and the entertainment equipment 112 may include a control chip or a control circuit for receiving a control command from the gateway communication filter 20, and executing the corresponding functional operations according to the control command.

The gateway communication filter 20 has one or more communication channels, and a user may perform the remote control through communications with the gateway communication filter 20 through the communication channel(s).

The network 30 is a communication network established according to Internet protocol transmission stand, and the gateway communication filter 20 may communicate with other electronic devices with Internet conductivity through the network 30. For example, Internet protocol transmission stand may be Transmission Control Protocol/Internet Protocol (TCP/IP) or User Datagram Protocol/Internet Protocol (UDP/IP). Further, in another embodiment of the invention, the network 30 is wireless local area network (Wi-Fi) established according to Local Area Network (LAN) protocol transmission stand. For example, this LAN protocol transmission stand is 802.11 series constituted by Institute of Electrical and Electronics Engineers (IEEE). However, the invention is not limited thereto.

The mobile communication device 40 is a mobile communication equipment of the user, which includes Subscriber Identity Module Card (SIM Card). The mobile communication device 40 is, for example, a cell phone, a personal digital assistant (PDA) phone, a smart phone, and so on. However, the invention is not intended to limit types of the mobile communication device 40.

The mobile phone network 50 is a telecommunication service provided by a telecommunication service provider, such as Global System For Mobile Communications (GSM), Code Division Multiple Access (CDMA), Personal Handy-phone System, (PHS) and so on.

In the present exemplary embodiment, the mobile communication device 40 is capable of communicating with the gateway communication filter 20 by ways of Short Message Service (SMS) or voices through the mobile phone network 50. In addition, after the authentication is passed, the mobile communication device 40 may perform the remote control on the power equipment 102, the lighting equipment 104, the security equipment 106, the air condition equipment 108, the appliance equipment 110, and the entertainment equipment 112 by using a web control interface or an application (APP) through the communication channel established by the gateway communication filter 20.

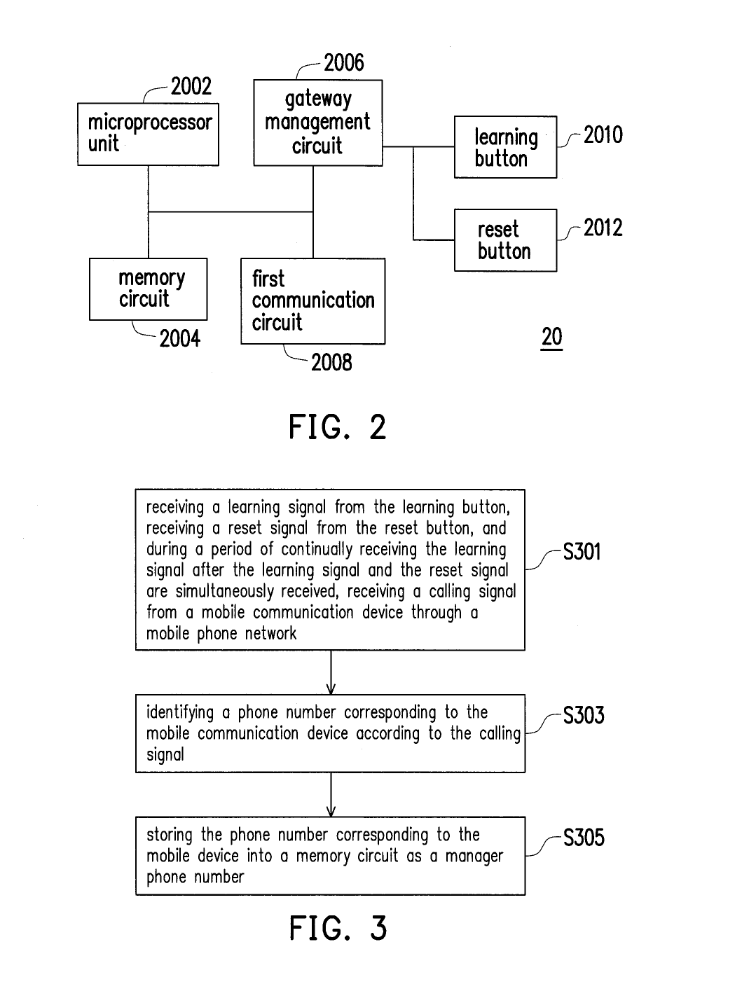

FIG. 2 is a block diagram illustrating a gateway communication filter according to an exemplary embodiment.

Referring to FIG. 2, the gateway communication filter 20 includes a microprocessor unit 2002, a memory circuit 2004, a gateway management circuit 2006, a first communication circuit 2008, a learning button 2010 and a reset button 2012.

The microprocessor unit 2002 may be a hardware with computing capabilities (e.g., a chip set, a processor and so on) which is configured to control overall operation of the gateway communication filter 20. In the present exemplary embodiment, the microprocessor unit 2002 is, for example, a central processing unit (CPU) or other programmable microprocessors, a digital signal processor (DSP), a programmable controller, an application specific integrated circuits (ASIC), a programmable logic device (PLD) or other similar devices.

The memory circuit 2004 is coupled to the microprocessor unit 2002. The memory circuit 2004 may be an embedded storage unit or an external storage unit. The embedded storage unit may be a random access memory (RAM), a read-only memory (ROM), a flash memory, a magnetic disk storage device, and so on. The external storage unit may be Compact Flash (CF) memory card, Secure Digital (SD) memory card, Micro SD memory card, Memory Stick (MS) memory card, and so on. Specifically, in the exemplary embodiments of the invention, the memory circuit 2004 is configured to store a mobile communication device number database (not illustrated) and capable of storing one or more programs or applications for controlling operation of the gateway communication filter 20.

The gateway management circuit 2006 is coupled to the microprocessor unit 2002, and configured to receive various signals, identify, and compare a phone number of the user. In another embodiment of the invention, the gateway management circuit 2006 is implemented in a manner of circuitry, but the invention is not limited thereto. For example, functions of the gateway management circuit 2006 may also be implemented in a manner of program codes stored in the memory circuit 2004. Further, when the gateway communication filter 20 is powered on, the microprocessor unit 2002 may run the program codes in order to execute the functions of the gateway management circuit 2006.

The first communication circuit 2008 is coupled to the microprocessor unit 2002 and operates by using a transmission stand or a protocol compatible with the mobile phone network 50. For example, the first communication circuit 2008 is capable of sending and receiving a short message or a voice signal through the mobile phone network 50.

The learning button 2010 is coupled to the gateway management circuit 2006. When the learning button 2010 is enabled, the gateway management circuit 2006 receives a learning signal.

The reset button 2012 is coupled to the gateway management circuit 2006. When the reset button 2012 is enabled, the gateway management circuit 2006 receives a reset signal.

In an exemplary embodiment, before performing a remote home control through the gateway communication filter 20, the user stores a manager phone number in advance, so that a phone call may be dialed by using the manager phone number to the gateway communication filter 20 for proceeding to subsequent processes of the remote home control. Specifically, a process of setting the manager phone number to the gateway communication filter 20 includes the following steps. First of all, the learning button 2010 and the reset button 2012 disposed on the gateway communication filter 20 are simultaneously pressed by the user. Next, the reset button 2012 is released but the learning button 2010 is continually pressed. At the time, an automatic learning function of the gateway communication filter 20 is activated. Thereafter, during a period in which the learning button 2010 is not released, the user may make the phone call to the gateway communication filter 20 by using the mobile communication device 40, so that the gateway communication filter 20 may identify the phone number of such phone call according to a calling signal and storing the phone number of the phone call as the manager phone number without answering the phone call.

Specifically, during a period of continually receiving the learning signal from the learning button 2010 after the learning signal from the learning button 2010 and the reset signal from the reset button 2012 are simultaneously received by the gateway management circuit 2006, when the first communication circuit 2008 receives the calling signal from the mobile communication device 40 through the mobile phone network 50, the gateway management circuit 2006 identifies the phone number of the mobile communication device 40 according to the calling signal, and stores the phone number into the memory circuit 2004 as the manager phone number.

Furthermore, in an exemplary embodiment, when the user intends to add other phone numbers for managing the gateway communication filter 20, the user may simply send these phone numbers to the gateway communication filter 20 through the short message by using the manager phone number already stored in the gateway communication filter 20. Specifically, the first communication circuit 2008 receives the short message from the mobile communication device 40 through the mobile phone network 50, and the short message contains the other phone numbers that the user intends to add for managing the gateway communication filter 20. Then, the gateway management circuit 2006 identifies the phone number of the mobile communication device 40 according to the short message. Once the phone number of the mobile communication device 40 is identified as the manager phone number, the gateway management circuit 2006 may store the other phone numbers in the short message into the memory circuit 2004.

It is worth mentioning that, in an exemplary embodiment, the gateway communication filter 20 may further include a second communication circuit (not illustrated). The second communication circuit (not illustrated) is coupled to the microprocessor unit 2002 and operates by using a transmission stand or a protocol compatible with the network 30 in order to send or receive packets through the network 30. Specifically, the gateway communication filter 20 uses the calling signal from the mobile communication device 40 or the other mobile communication devices to identify a calling number, and determines whether the calling number exists in the gateway communication filter 20. If the calling number is the manager phone number or the other phone numbers already stored in the gateway communication filter 20, the gateway communication filter 20 may establish a communication channel with the mobile communication device 40 or the other mobile communication devices corresponding to the phone call. Specifically, the gateway management circuit 2006 permits the second communication circuit (not illustrated) to establish the communication channel with the mobile communication device 40 and the other mobile communication devices corresponding to the other phone numbers according to the phone number and the other phone numbers stored in the memory circuit 2004.

FIG. 3 is a flowchart illustrating a gateway communication filter configuration method according to an exemplary embodiment.

Referring to FIG. 3, first, as shown in step S301, the gateway management circuit 2006 receives the learning signal from the learning button 2010; the gateway management circuit 2006 receives the reset signal from the reset button 2012; and during the period of continually receiving the learning signal after the learning signal and the reset signal are simultaneously received, the first communication circuit 2008 receives the calling signal from the mobile communication device 40 through the mobile phone network 50. Then, in step S303, the gateway management circuit 2006 identifies the phone number of the mobile communication device 40 according to the calling signal. Further, in step S305, the gateway management circuit 2006 stores the phone number into the memory circuit 2004 as the manager phone number.

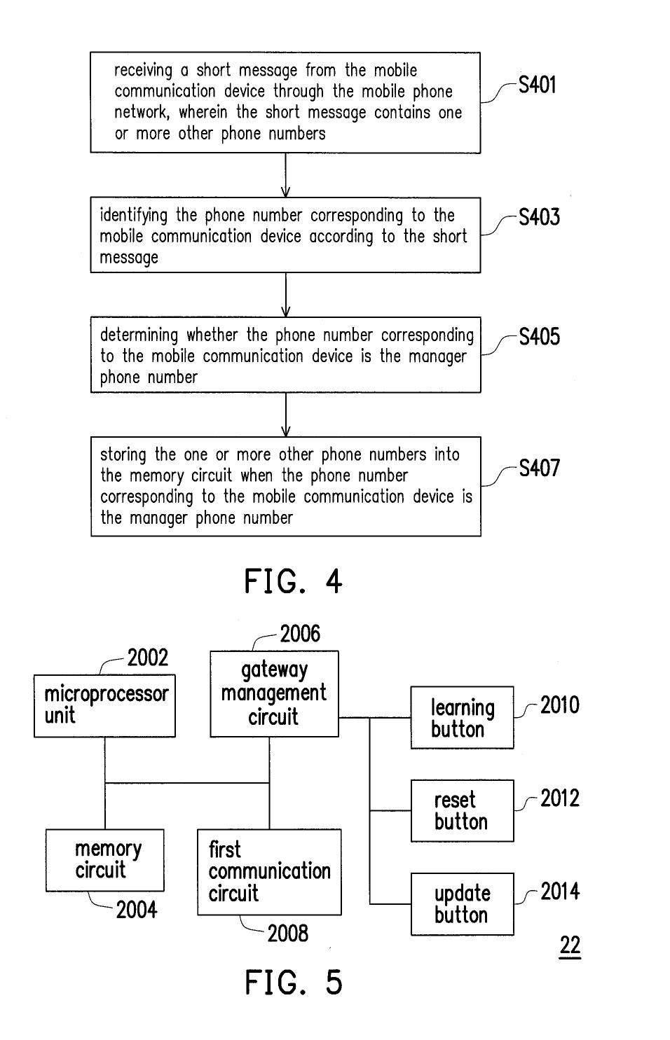

FIG. 4 is a flowchart illustrating a gateway communication filter configuration method according to another exemplary embodiment.

Referring to FIG. 4, first, as shown in step S401, the first communication circuit 2008 receives the short message from the mobile communication device 40 through the mobile phone network 50, wherein the short message contains the other phone numbers that the user intends to add for managing the gateway communication filter 20. Then, in step S403, the gateway management circuit 2006 identifies the phone number of the mobile communication device 40 according to the short message. Further, in step S405, the gateway management circuit 2006 determines whether the phone number corresponding to the mobile communication device 40 is the manager phone number. If the phone number of the mobile communication device 40 is the manager phone number, in step S407, the gateway management circuit 2006 stores the one or more phone numbers into the memory circuit 2004.

FIG. 5 is a block diagram illustrating a gateway communication filter according to another exemplary embodiment.

Referring to FIG. 5, a gateway communication filter 22 includes a microprocessor unit 2202, a memory circuit 2204, a gateway management circuit 2206, a first communication circuit 2208, a learning button 2210, a reset button 2212 and an update button 2214.

Structures of the microprocessor unit 2202, the memory circuit 2204, the gateway management circuit 2206, the first communication circuit 2208, the learning button 2210 and the reset button 2212 are substantially identical to the microprocessor unit 2002, the memory circuit 2004, the gateway management circuit 2006, the first communication circuit 2008, the learning button 2010 and the reset button 2012 respectively as disclosed in the embodiment of FIG. 2, and thus related descriptions are not repeated hereinafter.

The update button 2214 is coupled to the gateway management circuit 2206. When the update button 2214 is enabled, the gateway management circuit 2206 receives an update signal.

In an exemplary embodiment of the invention, when the update signal from the update button 2214 is received by the gateway management circuit 2206, the gateway management circuit 2206 receives an update boot code and replaces a boot code stored in the memory circuit 2204 with the update boot code in response to the update signal. For example, when the update signal is received after the update button 2214 is enabled, the gateway management circuit 2206 may download a new boot code from a remote server through the network 30, so that the new boot code may be used to replace an old boot code originally stored in the memory circuit 2204.

In summary, in the gateway communication filter and the gateway communication filter configuration method according the exemplary embodiments of the invention, the machine automatically learns and records the phone numbers of the users so that the users do not have input the phone numbers manually. Moreover, the user identity is identified through the authentication on the phone number before permitting the mobile communication device to establish the communication channel with the gateway communication filter. As a result, the users are able to operate the household equipments through the mobile communication device in convenient, secure, simple and easy manners.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A gateway communication filter, comprising:
a microprocessor unit;
a gateway management circuit coupled to the microprocessor unit;
a memory circuit coupled to the microprocessor unit;
a first communication circuit coupled to the microprocessor unit;
a learning button coupled to the gateway management circuit; and
a reset button coupled to the gateway management circuit,
wherein the gateway management circuit receives a reset signal when the reset button is enabled, and the gateway management circuit receives a learning signal when the learning button is enabled,
wherein during a period of continually receiving the learning signal after the learning signal and the reset signal are simultaneously received, when the first communication circuit receives a calling signal from a mobile communication device through a mobile phone network, the gateway management circuit identifies a phone number of the mobile communication device according to the calling signal, and stores the phone number into the memory circuit as a manager phone number.

2. The gateway communication filter of claim 1, wherein
the first communication circuit is further configured to receive a short message from the mobile communication device through the mobile phone network, wherein the short message includes one or more other phone numbers,
wherein the gateway management identifies the phone number of the mobile communication device according to the short message,
wherein the gateway management circuit stores the one or more other phone numbers into the memory circuit when the phone number of the mobile communication device is identified as the manager phone number.

3. The gateway communication filter of claim 1, further comprising:
an update button coupled to the gateway management circuit,
wherein the gateway management circuit receives an update signal when the update button is enabled,
wherein the gateway management circuit receives an update boot code and replaces a boot code stored in the memory circuit with the update boot code in response to the update signal.

4. The gateway communication filter of claim 2, further comprising a second communication circuit,
wherein the gateway management circuit permits the second communication circuit to establish a communication channel with the mobile communication device and one or more other mobile communication devices corresponding to the one or more other phone numbers according to the phone number and the one or more other phone numbers stored in the memory circuit.

5. A gateway communication filter configuration method, executed by a gateway communication filter disposed with a learning button and a reset button, and the gateway communication filter configuration method comprising:
receiving a learning signal from the learning button;
receiving a reset signal from the reset button;
during a period of continually receiving the learning signal after the learning signal and the reset signal are simultaneously received and, receiving a calling signal from a mobile communication device through a mobile phone network;
identifying a phone number corresponding to the mobile communication device according to the calling signal; and
storing the phone number corresponding to the mobile device into a memory circuit as a manager phone number.

6. The gateway communication filter configuration method of claim 5, further comprising:
receiving a short message from the mobile communication device through the mobile phone network, wherein the short message includes one or more other phone numbers;
identifying the phone number corresponding to the mobile communication device according to the short message;
determining whether the phone number corresponding to the mobile communication device is the manager phone number; and
storing the one or more other phone numbers into the memory circuit when the phone number corresponding to the mobile communication device is the manager phone number.

7. The gateway communication filter configuration method of claim 5, further comprising:
receiving an update signal from an update button of the gateway communication filter;
receiving an update boot code; and
replacing a boot code stored in the memory circuit with the update boot code in response to the update signal.

8. The gateway communication filter configuration method of claim 6, further comprising:
permitting the gateway communication filter to establish a communication channel with the mobile communication device and one or more other mobile communication devices corresponding to the one or more other phone numbers according to the phone number and the one or more other phone numbers stored in the memory circuit.
